(19) United States
(12) Patent Application Publication
(10) Pub. No.: US 2012/0318921 A1
(43) Pub. Date: Dec. 20, 2012

(54) FIRE PROTECTION SYSTEM, AIRCRAFT OR SPACECRAFT AND A METHOD FOR CONFINING AND SUPPRESSING A FIRE

(75) Inventors: PAUL ROHRBACH, Bremen (DE); RAINER BEUERMANN, Bremen (DE); ROBERT HÜBNER, Bremen (DE)

(73) Assignee: AIRBUS OPERATIONS GMBH, Hamburg (DE)

(21) Appl. No.: 13/523,395

(22) Filed: Jun. 14, 2012

Related U.S. Application Data
(63) Continuation of application No. PCT/EP2010/069118, filed on Dec. 8, 2010.
(60) Provisional application No. 61/287,386, filed on Dec. 17, 2009.

(30) Foreign Application Priority Data
Dec. 17, 2009 (DE) 10 2009 054 886.6

(51) Int. Cl. A62C 3/08; A62C 2/00

(52) U.S. Cl. 244/129.2; 169/56; 169/46

(57) ABSTRACT

The invention provides a fire protection system, in particular in the field of aviation and aerospace, comprising a compartment which is at least partly lined with fire-retardant material, a detection means which can detect a fire in the compartment, and a fire suppression means which is configured to introduce an inert gas into the compartment when the detection means detects a fire in the compartment, to thus reduce the oxygen content in the compartment and to thereby suppress the fire.

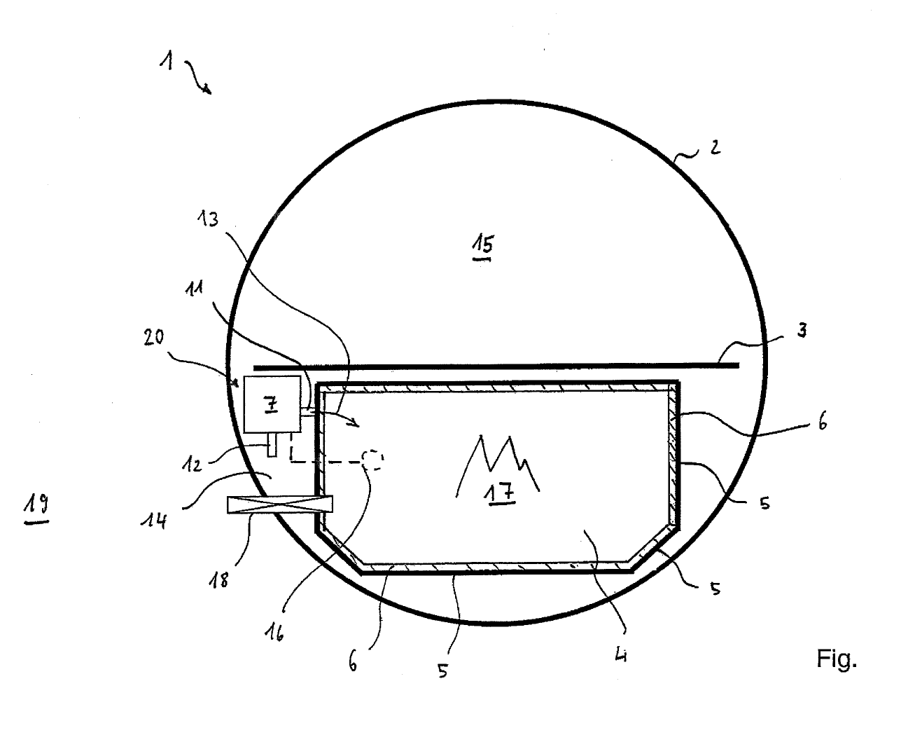

### CROSS REFERENCE TO RELATED APPLICATIONS

This application is a continuation of and claims priority to PCT/EP2010/069118 filed Dec. 8, 2010 which claims the benefit of and priority to U.S. Provisional Application No. 61/287,386, filed Dec. 17, 2009 and German patent application No. 10 2009 054 886.6, filed Dec. 17, 2009, the entire disclosures of which are herein incorporated by reference.

### FIELD OF THE INVENTION

The present invention relates to a fire protection system, to an aircraft or spacecraft and to a method for confining and suppressing a fire.

### BACKGROUND OF THE INVENTION

Although the present invention and the problem it addresses can be applied to any compartments, they will be described in detail with regard to the hold of an aircraft.

DE 101 52 964 C1 describes a fire protection system for the hold of an aircraft. The fire protection system comprises a pressure vessel filled with pressure-liquefied halon. If a fire is detected in the hold, halon is conducted out of the pressure vessel into the hold and there it extinguishes the fire or at least suppresses it; in other words the fire is confined to the hold until the aircraft has landed.

A problem of using halon is that it is very harmful to the environment and therefore, in the foreseeable future, it will no longer be considered for use in the field of aviation.

### SUMMARY OF THE INVENTION

An aspect of the present invention is therefore to provide a fire protection system, an aircraft or spacecraft and/or a method for at least suppressing a fire which avoids the drawback described above.

This aspect is achieved by a fire protection system having the features of claim 1, by an aircraft or spacecraft having the features of claim 8 and/or by a method having the features of claim 10.

Accordingly, a fire protection system, particularly in the field of aviation and aerospace, is provided which comprises the following: a compartment which is at least partly lined with a fire-retardant material; a detection means which can detect a fire in the compartment; and a fire suppression means which is set up to introduce an inert gas into the compartment when a fire has been detected in the compartment by the detection means to thus reduce the oxygen content in the compartment and to thereby suppress the fire.

An aircraft or spacecraft having the fire protection system according to the invention is also provided.

Furthermore, a method for containing and suppressing a fire in a compartment is provided, in which method an inert gas is introduced into the compartment when a fire is detected in the compartment to thus reduce the oxygen content in the compartment and to thereby suppress the fire, the volume of inert gas introduced per unit of time and a fire-retardant material which lines the compartment being coordinated with one another such that the fire is prevented from burning through the fire-retardant material.

The idea addressed by the present invention is to combat a fire in a compartment in two ways. Firstly, this is performed in a passive manner through the provision of a fire-retardant material. Secondly, it is performed in an active manner by introducing an inert gas into the compartment, thus reducing the oxygen content in the compartment and, as a result, suppressing the fire.

An advantage of a fire protection system of this type is that inert gases are environmentally friendly, compared to halon gas.

A further advantage of a fire protection system of this type is that a relatively long period of time is available for introducing a sufficient quantity of the inert gas into the compartment, namely until the fire has almost burnt through the fire-retardant material. This gain in time makes it possible in the first place to use inert gas to effectively suppress the fire. Compared to halon gas which reacts chemically with the fire and thereby extinguishes it, inert gases merely reduce and displace the oxygen contained in the air, which is why when fighting fire with inert gas, substantially greater quantities of inert gas have to be provided than is the case when halon gas is used, which is accordingly more time-consuming.

Advantageous configurations and developments of the invention are provided in the subclaims.

In the present context, an “inert gas” is understood as meaning a gas which is very poorly reactive and therefore only participates to a slight extent in chemical reactions. In the present context, the term “inert gas” denotes in particular nitrogen, nitrogen-enriched air, oxygen-depleted air, carbon dioxide and all noble gases (helium, neon, argon, krypton, xenon) as well as mixtures of these gases. The nitrogen content of the nitrogen-enriched air is preferably between 85 and 100%, more preferably between 95 and 100% (in the present invention, percentages always relate to percent by volume).

In the present invention, the inert gas serves to reduce or to completely replace the oxygen content in the air and to absorb the reaction heat of the fire, thereby at least preventing the fire from being able to spread any further. Here, the suppression of the fire is also to include the case in which the fire is extinguished.

According to a preferred development of the fire protection system according to the invention, the fire suppression means has a fuel cell which depletes air from outside the compartment in respect of the oxygen contained in the air for introducing the air into said compartment, in that the fuel cell uses the oxygen contained in the air at least to some extent for combustion. The fuel cell consumes oxygen, as a result of which oxygen-depleted air is simultaneously produced. To then use this “waste product” for long-term fire suppression is advantageous because it means that the inert gas does not have to be carried on board an aircraft stored in pressure vessels, for example, but instead can be produced on board the aircraft itself. The fuel cell is preferably a proton exchange membrane fuel cell (PEM fuel cell). It is possible to use other types of fuel cells.

According to a further preferred development of the fire protection system according to the invention, the fire suppression means has an air separator which depletes air from outside the compartment in respect of the oxygen contained in the air for introducing the air into said compartment, in that the air separator at least partly filters out the oxygen contained in the air. The air outside the compartment is thus separated into a nitrogen-rich air flow and into an oxygen-rich air flow. The nitrogen-rich air flow is introduced into the compartment. An air separator of this type can be, for example, a PRISM® nitrogen membrane, as marketed by “Airproducts and Chemicals, Inc.”.

According to a further preferred development of the fire protection system. according to the invention, the fuel cell or the air separator is arranged outside the compartment and is connected to said compartment by a line for introducing the oxygen-depleted air. This measure provides a favourable construction.

According to a further preferred development of the fire protection system according to the invention, the fire-retardant material is configured as an intumescent material. In the present context, the term “intumescent material” is understood as meaning a material which, under the effect of heat from a fire, forms a non-combustible protective layer or a very poorly combustible protective layer and thus significantly delays the burning of the fire through the compartment delimitation lined by the fire-retardant material. This layer formed by the effect of heat is also a thermal insulation layer which protects the surroundings as well as the system and structural components located outside the compartment from the fire and from the effects thereof, such as smoke and thermal radiation.

According to a further preferred development of the fire protection system according to the invention, a valve is provided between the compartment and the surroundings thereof, which valve is set up to release in a controlled manner a pressure which builds up in the compartment due to the fire and/or due to the introduction of inert gas. The inert gas which has been introduced is to displace from the hold the relatively oxygen-rich air which is, for example, present in the hold of the aircraft, for which purpose, according to this development, the hold is advantageously provided with a suitable valve which allows a displacement of this type.

According to a further preferred development of the aircraft or spacecraft according to the invention, the compartment is configured as a hold.

According to a further preferred development of the aircraft or spacecraft according to the invention, it is possible to produce the inert gas on board the aircraft or spacecraft. This affords the advantage that, for example, relatively heavy pressurised gas cylinders filled with the inert gas do not have to be carried on the aircraft or spacecraft.

### BRIEF DESCRIPTION OF THE DRAWING

In the following, the invention will be described in detail based on embodiments with reference to the accompanying FIGURE of the drawing.

The FIGURE schematically shows a section through an aircraft 1 according to an embodiment of the present invention.

### DETAILED DESCRIPTION OF THE INVENTION

In the FIGURE, the same reference numerals denote identical or functionally identical components, unless indicated otherwise.

The aircraft 1 has a fuselage 2 with a central floor 3. A hold 4 is arranged beneath the floor 3. The hold 4 is delimited by wall elements 5. The wall elements 5 preferably each have an intumescent material on the inside of the hold.

The aircraft 1 also has a fire suppression means 7 which is connected to the hold 4 by a line 11. The fire suppression means 7 which, according to the present embodiment, is configured as a fuel cell also has a connection 12. By means of said connection 12, the fire suppression means 7 takes up air from the surroundings 14 of the hold 4, for example it takes up air from the cabin 15, and burns the oxygen contained in the air at least to some extent with hydrogen with the release of electrical energy. An inert gas 13 is produced during the combustion. The inert gas 13 has, for example, a nitrogen content of approximately 87%. Therefore, the nitrogen content is increased compared to the “normal” air in the surroundings 14 which has a nitrogen content of approximately 78%. The fire suppression means 7 is configured to introduce the inert gas 13 into the hold 4 by means of the line 11 in the event of a fire.

An air filter (not shown) could also be used instead of the fuel cell 7. This air filter would then filter out the oxygen contained in the air supplied via the connection 12 and would provide the inert gas 13 formed in this way at line 11.

The fire suppression means 7 is connected in terms of signaling to a detection means 16 which is configured to detect a fire 17 in the hold 4.

Furthermore, the hold 4 can be connected to the atmosphere 19 surrounding the aircraft 1 by a valve 18.

In this respect, the components 4, 6, 7, 11, 12, 16 and 18 form a fire protection system 20, the mode of operation of which will be briefly described in the following.

Normally, the fuel cell 7 is used to generate electrical current, for example to operate a cabin illumination system (not shown). As it could be harmful to the health of passengers in the cabin, the inert gas 13 produced thereby (fuel cell waste gas) is released for example into the atmosphere 19 in a manner not described in more detail.

If a fire 17 then starts in the hold 4, the resulting heat leads to the intumescent material 6 forming a substantially non-combustible, thermally-insulating protective layer. This provides a passive fire protection which, for a certain amount of time, for example for 25 minutes, prevents the fire 17 from penetrating through the wall elements 5 into the cabin 15 and thus through to the passengers. Without further measures, the fire 17 would have completely destroyed the intumescent material 6 after about 25 minutes and would then spread to the cabin 15.

For this reason, the fire protection system 20 has the fire suppression means 7 to deal with the fire 17 in an active manner. The detection means 16 indicates to the fire suppression means 7 that a fire 17 has started in the hold 4. Thereupon, the fire suppression means 7 is connected such that the inert gas 13 is conducted into the hold 4 by the line 11. As a result, the oxygen content in the air remaining in the hold 4 is continuously reduced until after 20 minutes, for example, the oxygen content in the air in the hold 4 has fallen from initially about 21% to about 12 to 10%. The effect of this low oxygen content is that the fire 17 cannot spread any further or that it will even extinguish itself. The intumescent material 6 is configured, for example in respect of its thickness, such that according to the present embodiment, it will withstand the fire 17 for 25 minutes, i.e. at least until the oxygen content in the hold 4 has fallen to such a level that the fire 17 cannot spread any further.

To prevent excess pressure in the hold 4 which can arise, on the one hand, due to the introduction of inert gas 13 and/or, on the other, due to the resulting combustion gases, the valve 18 is opened to release a corresponding excess pressure into the atmosphere 19.

Although the invention has been described above on the basis of preferred embodiments, it is not restricted thereto, but can be modified in many different ways. In particular, the word “one” does not exclude a plurality here. Furthermore, the developments and embodiments described here for the fire protection system can be applied accordingly to the aircraft or spacecraft or to the method for suppressing a fire, and vice versa.

What is claimed is:

1. A fire protection system, in particular in the field of aviation and aerospace, comprising:
a compartment which is at least partly lined with a fire-retardant material;
a detection means which can detect a fire in the compartment; and
a fire suppression means which is configured to introduce an inert gas into the compartment when the detection means detects a fire in the compartment to thus reduce the oxygen content in the compartment and to thereby suppress the fire, the volume of inert gas introduced per unit of time and the fire-retardant material which lines the compartment being coordinated with one another such that the fire is prevented from burning through the fire-retardant material.

2. The fire protection system of claim 1, wherein the inert gas is selected from the group consisting of nitrogen, nitrogen-enriched air, oxygen-depleted air, carbon dioxide, helium, neon, argon, krypton and xenon, or mixtures thereof.

3. The fire protection system of claim 2, wherein the fire suppression means comprises a fuel cell which depletes air from outside the compartment in respect of the oxygen contained in the air for introducing the air into the compartment, in that the fuel cell uses the oxygen contained in the air at least to some extent for combustion.

4. The fire protection system of claim 2, wherein the fire suppression means comprises an air separator which depletes air from outside the compartment in respect of the oxygen contained in the air for introducing the air into the compartment, in that the air separator at least partly filters out the oxygen contained in the air.

5. The fire protection system of claim 2, wherein the fuel cell or the air separator is arranged outside the compartment and is connected to said compartment by a line for introducing the oxygen-depleted air.

6. The fire protection system of claim 1, wherein the fire-retardant material is configured as an intumescent material.

7. The fire protection system of claim 1, wherein provided between the compartment and the surroundings thereof is a valve which is arranged to release in a controlled manner a pressure which builds up in the compartment due to the fire and/or due to the introduction of the inert gas .

8. An aircraft or spacecraft having a fire protection system comprising the features of claim 1.

9. The aircraft or spacecraft of claim 8, wherein the inert gas can be produced on board the aircraft or spacecraft.

10. Method for confining and suppressing a fire in a compartment, wherein an inert gas is introduced into the compartment when a fire is detected in the compartment to thus reduce the oxygen content in the compartment and to thereby suppress the fire, the volume of inert gas introduced per unit of time and a fire-retardant material which lines the compartment being coordinated with one another such that the fire is prevented from burning through the fire-retardant material.
